(19) United States
(12) Patent Application Publication
(10) Pub. No.: US 2024/0108919 A1
(43) Pub. Date: Apr. 4, 2024

(54) Assistive Respiration Apparatus

(71) Applicant: Cartonmaster International (2012) Incorporated, Toronto (CA)

(72) Inventor: Allan Russell Prittie, Toronto (CA)

(21) Appl. No.: 18/480,884

(22) Filed: Oct. 4, 2023

Related U.S. Application Data
(60) Provisional application No. 63/413,124, filed on Oct. 4, 2022.

(51) Int. Cl. A62B 7/12; A62B 7/02; A62B 7/10; A62B 9/02; A62B 18/04; A62B 18/10; A62B 23/02

(52) U.S. Cl. CPC A62B 7/12; A62B 7/02; A62B 7/10; A62B 9/022; A62B 18/045; A62B 18/10; A62B 23/02

(57) ABSTRACT

A breathing apparatus and method adjusting air flow in a breathing apparatus are provided. The breathing apparatus comprises: a first face piece for directing a flow of air towards the user's mouth and nostrils; a second face piece for directing exhaled breath away from the user's mouth and nostrils; at least one sensor, coupled to the first or second face piece, for monitoring the user's breathing; a controller that adjusts the flow of air to the first face piece and the extraction of air exhaled by the user through the second face piece based on an output from the at least one sensor.

### FIELD

The subject disclosure relates generally to breathing apparatus and in particular, to a personal air purifying respiration apparatus.

### BACKGROUND

There are certain pathogens that are airborne and may be transmitted from person to person through the air that is breathed. Typically transmission of such pathogens is via droplets and airborne aerosolised particles expelled by an infected person during coughing, laughing, spitting, and by normal breathing. Certain viruses can be effectively shed, aerosolised, and transmitted by the infected person, however effective reception by a recipient relates to the dose shed by the infected person, proximity to the infected person while they are shedding a viral load, and the duration of exposure of the recipient to the infected person. In an Intensive Care Unit environment, an infected person can be shedding and expelling a very high dose of aerosolised pathogens in very close proximity to staff and healthcare professionals, and for extended periods of time. This exposes staff and healthcare professionals to a high risk of infection unless proper protective equipment is being worn.

Suitable protective equipment against droplets and aerosolised particles can take the form of tightly fitting partial facemasks and other Personal Air Purifying Respirators (PAPR) systems and devices. For example, U.S. Pat. No. 9,968,749 discloses a respiration system for non-invasive respiration. The system includes a respiration drive, which is controlled by a control device, and includes a patient module with electrodes for picking up electrode signals from the surface of the chest of a patient. The control device is set up to suppress ECG signals in the electrode signals in order to obtain electromyographic signals (EMG signals) representing the breathing effort and to control the respiration drive as a function of the EMG signals. Provisions are made for deriving ECG signals from the electrode signals before said ECG signals are suppressed and for making data representative of the ECG available for display.

Canadian Patent Application No 2,460,350 discloses a device sensor comprising a piezoelectric bar or rod that monitors respiratory movements by picking up changes in the abdomen's curvature in the cephalocaudal direction.

U.S. Pat. No. 8,109,269 discloses a method of automatically controlling a respiration system for proportional assist ventilation with a control device and with a ventilator. An electrical signal is recorded by electromyography with electrodes on the chest in order to obtain a signal uemg(t) representing the breathing activity. The respiratory muscle pressure pmus(t) is determined by calculating it in the control unit from measured values for the airway pressure and the volume flow Flow(t) as well as the patient's lung mechanical parameters. The breathing activity signal uemg(t) is transformed by means of a preset transformation rule into a pressure signal pemg(uemg)(t)) such that the mean deviation of the resulting transformed pressure signal pemg(t) from the respiratory muscle pressure pmus(t) is minimized. The respiratory effort pressure ppat(t) is determined as a weighted mean according to ppat(t)=a·pmus(t)+(1−a)·pemg(t), where a is a parameter selected under the boundary condition 0≤/a≤/1. However, the device disclosed in U.S. Pat. No. 8,109,269 is invasive and can only be used on an anesthetised patient, effectively as a ventilator.

In a preliminary media release, LG of South Korea disclosed PuriCare. This device utilises dual fans and filters, each acting to provide individually constant air pressure. It assists the user to breathe in filtered air and then to filter air which is exhaled. Based on a respiratory sensor and control system, it automatically adjusts the average fan speed to respond to the users average breathing rate.

U.S. Pat. No. 8,667,959 discloses a modular powered air purifying respirator (PAPR) which is comprised of a fan, motor, scroll, and power source mounted within one housing, and which accepts either traditional or conformal filters. Ambient air is drawn into the PAPR module through the attached filter by a fan, which is driven by direct connection to a motor. The pressurized air is then accelerated by an optimized scroll to the outlet in the PAPR housing. The PAPR module can be employed in multiple use configurations. The PAPR module further comprises a removable battery pack module that is easily retained to/removed from the PAPR module, enabling a user to be able to quickly remove a spent battery pack module and install a fresh battery pack module, thereby replacing the batteries within one breath cycle.

A common disadvantage seen in the respiration systems disclosed in U.S. Pat. No. 9,968,749, CA 2,460,35, and Puricare, is that they do not respond to the immediate rate of change in the user's inhalation and exhalation. This means that the respiration systems may be out of phase with the user's breathing pattern if and when it is trying to assist the exhalation of carbon dioxide and other associated discharges from the user's body.

Furthermore, the expelled carbon dioxide and other associated gases produced during the user's exhalation cannot be and are not substantially completely pushed through the exit filter and can therefore be present during the user's next intake of breath.

### SUMMARY

In one aspect, there is provided a breathing apparatus comprising: a face piece comprising: a first face piece portion configured to direct a flow of air towards a user when in use; a second face piece portion configured to direct exhaled breath away from the user when in use; and at least one sensor configured to monitor the user's breathing; and a controller configured to adjust the flow of air to the first face piece portion and the extraction of exhaled breath from the second face piece portion in response to an output from the at least one sensor.

The at least one sensor may detect a variation in air movement, a variation in humidity level, a variation in carbon dioxide level, and/or a variation in instantaneous temperature.

The breathing apparatus may further comprise a shroud for covering a user's head and shoulders. The breathing apparatus may further comprise a weight bearing assembly to rest on the user's shoulders.

The first face piece portion may be coupled to an inflow tube having an inflow air impeding valve, downstream from which are a gas chamber, a one-way valve, a manifold, an intake fan, and an intake filter.

The controller may be configured to control the inflow air impeding valve, the one-way valve, and the intake fan.

The second face piece portion may be coupled to an outflow tube having an exhaust air impeding valve, downstream from which are an exhaust fan and an exhaust filter.

The controller may be configured to control the exhaust air impeding valve and the exhaust fan.

The manifold may be coupled to an environment tube, having a flow regulating valve, for directing air into the shroud.

A gas supply tube may be coupled to the gas chamber and a gas canister and include a flow regulating valve for manually adjusting an output of the gas canister into the gas chamber.

The controller may be configured to: calculate a rate of change of inhalation and a rate of change of exhalation based on an output of the at least one sensor; control the inflow air impeding valve, the one-way valve, and the intake fan to provide the flow of air based on the rate of change of inhalation; and control the exhaust air impeding valve and the exhaust fan to extract the exhaled air based on the rate of change of exhalation.

In another aspect, there is provided a method of adjusting air flow in a breathing apparatus, comprising: providing a flow of air to a user through a first face piece portion of a face piece; extracting exhaled air away from the user through a second face piece portion of the face piece; sensing, with at least one sensor, a variation in the user's breathing; and sending to a controller, by the at least one sensor, a signal representing the variation; adjusting by the controller, in response to the signal, the flow of air through the first face piece portion and the extraction of exhaled air through the second face piece portion.

The providing a flow of air may comprise operating an intake fan, by the controller, to draw ambient air into an inflow tube; filtering the ambient air to remove any contaminants; and raising the pressure of the filtered air at a manifold.

The providing the flow of air may further comprise dividing the flow of filtered air between the inflow tube and an environment tube at the manifold.

The method may further comprise manually opening a flow regulating valve in the environment tube to supply a portion of the filtered air into the shroud.

The providing the flow of air may further comprise mixing a portion of filtered air with oxygen in a gas chamber; and opening an inflow air impeding valve, by the controller, to supply the mixed air to the first face piece portion.

The supplying oxygen from a canister may be manually controlled by the user.

The extracting may comprise opening an exhaust air impeding valve by the controller; drawing exhaled air away from user's mouth and nostrils by an exhaust fan; filtering the exhaled air through an exhaust filter to substantially remove contaminants; and exhausting the filtered exhaled air.

The sensing may comprise sensing at least a variation in air movement.

The adjusting may comprise analysing, by the controller, the output from the at least one sensor; calculating, by the controller, a rate of change of the user's inhalation; predicting, by the controller, the next upcoming inhale; and controlling, by the controller, the inflow air impeding valve, the one-way valve, and the intake fan to provide the flow of air based on the rate of change of inhalation.

The adjusting may comprise analysing, by the controller, the output from the at least one sensor; calculating, by the controller, a rate of change of the user's exhalation; predicting, by the controller, the next upcoming exhale; and controlling, by the controller, the exhaust air impeding valve, and the exhaust fan to extract the exhaled air based on the rate of change of exhalation.

### BRIEF DESCRIPTION OF DRAWINGS

Embodiments will now be described more fully with reference to the accompanying drawings in which:

FIG. 1 is a side view showing a user wearing the PAPR according to one embodiment;

FIG. 2 is a front view of the user and PAPR according to one embodiment;

FIG. 3 is a graphical representation of two cycles of a human breathing pattern; and

FIG. 4 is a graphical representation of one cycle of a human breathing pattern with a differing amplitude and frequency to FIG. 3.

### DETAILED DESCRIPTION

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “affixed” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly affixed” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can, however, encompass different orientations in use or operation in addition to the orientation depicted in the figures.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within engineering tolerances that would be readily appreciated by a person skilled in the art.

The following describes a Personal Air Purifying Respirator (PAPR) for use in, for example, a healthcare environment by healthcare professionals to assist and direct the intake of air by the user and to assist and redirect the exhalation of air by the user, including droplets, aerosolized pathogens, and other gases. The PAPR senses, among other parameters, the user's breathing. The PAPR is equipped with a controller which, using sensors, collects and processes information about these parameters. The controller anticipates, based on the processed information, the user's next upcoming inhale and exhale. The controller adjusts the air intake, and consequently the flow of air supplied to the user through the PAPR, based on the anticipated inhale. The controller also adjusts the extraction of the exhaled air away from the nostrils and mouth of the user based on the anticipated exhale. Healthcare professionals may be doctors, nurses, EMTs, long-term care home staff and residents, and hospitalised patients, and the like.

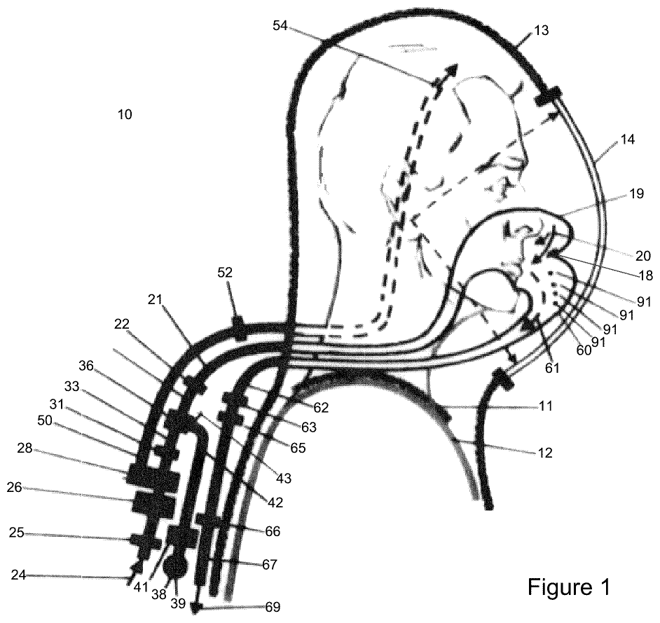

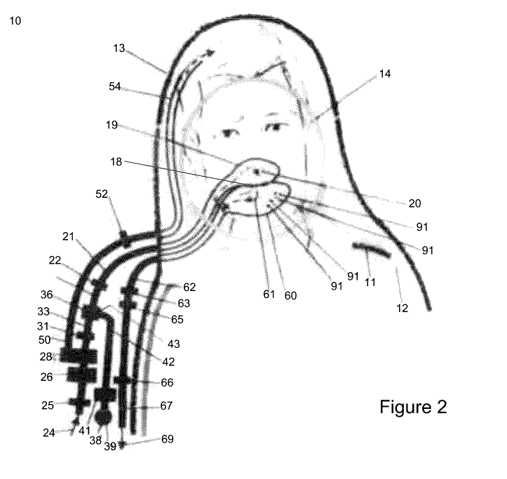

FIGS. 1 and 2 show a PAPR 10 including a shroud 13 with a transparent window 14 and a weight bearing assembly 11. Inside the shroud 13 is a face piece 18 comprising a first face piece portion 19 and a second face piece portion 60. The face piece 18 includes sensors 91. In the present embodiment, the second face piece portion 60 includes the sensors 91. The PAPR 10 also includes a plurality of tubes, including an inflow tube 21; a gas supply tube 42; an environment tube 54; an outflow tube 62; and an exhaust tube 67. The PAPR 10 further includes an inflow air impeding valve 22; a one-way valve 31; a flow regulator 41; a flow regulating valve 52; an exhaust air impeding valve 63; an intake fan 26; an exhaust fan 65; an intake filter 25; an exhaust filter 66; a gas chamber 36 having a filtered air inlet port 33 and a gas inlet port 43; a manifold 28 having a port 50; and a gas canister 39.

The shroud 13 can be of a type well known in the art and includes a transparent window 14 to allow the user a wide field of vision. The transparent window 14 is connected to the shroud 13 to create a seal to prevent the ingress or egress of air. The shroud 13 of the PAPR 10 in the embodiment drapes over the user's head and shoulders 12 and may also cover a portion of the user's back and chest. The shroud 13 is loosely-fitting over the head and shoulders 12 and is configured to minimize uncontrolled leakage of gases into the shroud 13 and out to the ambient environment.

The weight bearing assembly 11, situated inside the shroud 13, rests on the user's shoulders 12. The weight bearing assembly 11 may be adjustable to comfortably fit the user. The weight bearing assembly 11 distributes the weight of the shroud 13 and other components of the PAPR 10 away from the head and face to the shoulders 12 to maximize user comfort over periods of time.

The first face piece portion 19 and the second face piece portion 60 are positioned inside the shroud 13 and may be connected together. The first face piece portion 19 directs a flow of air 20 towards the user's nostrils and mouth for them to inhale. The flow of air 20 is filtered and pressurized, and if required, it is mixed with oxygen 38 to provide oxygen-enriched air.

The second face piece portion 60 channels and directs exhaled air 61 which has been drawn by exhaust fan 65 away from the user's nostrils and mouth, including carbon-dioxide, other expelled gases, and any droplets or aerosolized pathogens. The second face piece portion 60 may also attach to the weight bearing assembly 11.

The first face piece portion 19 connects to the inflow tube 21. The second face piece portion 60 connects to the outflow tube 62. The environment tube 54 runs inside the shroud 13. When the controller determines that the user is about to inhale, the flow of air 20 is delivered to the user via the inflow tube 21 and the first face piece portion 19. Sequentially, when the controller determines that the user is about to exhale, the second fan 63, via the face piece portion 60 and the outflow tube 62, pulls the exhaled air 61 away from the user. The environment tube 54 supplies air to inside the shroud 13 which increases the pressure and prevents ambient air and potential pathogens from entering the shroud.

Outside the shroud 13, the environment tube 54 connects to the flow regulating valve 52 and the manifold 28. The inflow tube 21 connects to the inflow air impeding valve 22, upstream from which are the gas chamber 36, the one-way valve 31, the manifold 28, the intake fan 26 and the intake filter 25, where ambient air 24 is drawn into the PAPR 10. Connecting into the gas chamber 36 is the gas supply tube 42 that connects to the flow regulator 41 and the gas canister 39 which may hold oxygen 38 or similar gases. The outflow tube 62 connects to the exhaust air impeding valve 63, downstream from which are the exhaust fan 65, and the exhaust filter 66. The exhaust tube 67 connects to the exhaust filter 66 and expels filtered, exhaled air 69 from the PAPR 10.

Sensors 91 are positioned inside the second face piece and detect at least a variation in air movement. However, it will be appreciated that the sensors 91 may also detect a variation in humidity level, carbon dioxide level, and instantaneous temperature. The sensors 91 communicate the detected variations in parameters to the controller (not shown) as signals. There may be one sensor 91 for detecting multiple parameters, or one individual sensor 91 for detecting each parameter. The controller may be housed in a small, wearable bag or similar that may be worn around and supported by the user's shoulders 12. The small, wearable bag may also house the gas canister 39 and the valves 22, 31, 63 and regulators 41, 52.

Each sensor 91 is equipped with an onboard processor. In the case of the sensor 91 sensing carbon dioxide, the sensor 91, continually collects and discharges air exhaled by the user. The sensor 91 detects that the carbon dioxide content continuously varies from a first level (e.g., a baseline level or “0”), which is indicative of when the user is about to inhale, to a second level (e.g., a level that is greater than the baseline level), which is indicative of when the user is about to exhale. When the user is about to exhale the carbon dioxide content level begins to rise. The sensor's 91 onboard processor takes this information, converts it to an intermittent rising and lowering signal depending upon the instantaneous, imminent frequency of breathing and amplitude of breathing.

In the case of the sensor 91 sensing air movement, the sensor 91 may be configured to detect air flow in both directions to indicate when the user is inhaling and exhaling. The sensor 91 detects the variation of air movement continuously from one direction to the other. The sensor 91 detects a decrease in air movement in one direction as the user completes an inhale and is about to exhale. As the user begins to exhale the air movement begins to increase in the other direction. The sensor's 91 onboard processor takes this information, converts it to an intermittent rising and lowering signal depending upon the instantaneous, imminent frequency of breathing and amplitude of breathing.

In the case of the sensor 91 sensing humidity, the sensor 91 continually collects and discharges air exhaled by the user. The sensor 91 detects that the humidity content continuously varies from a first humidity level (e.g., a baseline humidity level or “0”), which is indicative of when the user is about to inhale, to a second humidity level (e.g., a humidity level that is greater than the baseline level) which is indicative of when the user is about to exhale. When the user is about to exhale the humidity content level begins to rise. The sensor's 91 onboard processor takes this information, converts it to an intermittent rising and lowering signal depending upon the instantaneous, imminent frequency of breathing and amplitude of breathing.

In the case of the sensor 91 sensing instantaneous temperature, the sensor 91 continually collects and discharges air exhaled by the user. The sensor 91 detects that the temperature level continuously varies from a lower temperature level, which is indicative of when the user is about to inhale, to a higher temperature level which is indicative of when the user is about to exhale. When the user is about to exhale the temperature level begins to rise. The sensor's 91 onboard processor takes this information, converts it to an intermittent rising and lowering signal depending upon the instantaneous, imminent frequency of breathing and amplitude of breathing.

The sensor's onboard processor provides the continuous, but varying stream of signals, usually by wires although other methods such as Bluetooth may also be used, to the controller. The controller accordingly then operates the appropriate components based on whether an inhale or exhale is anticipated.

The controller operates several components within the PAPR 10, including the inflow air impeding valve 22, and the exhaust air impeding valve 63, the intake fan 26, the exhaust fan 65, and the one-way valve 31. The flow regulator 41, and the flow regulating valve 52 are manually controlled by the user.

Sensors 91 detect the variation in parameters at the user's nostrils and mouth in the second face piece portion 60. The sensors 91 generate signals, either individually or in coordination with each other, which are collected and recorded and supplied to the controller. The controller processes the signals from the sensors 91, and uses algorithms to predict, and then to assist, the user's next upcoming inhale of filtered and mixed air 20. The algorithms are based on the always changing frequency and amplitude of the user's detected breathing pattern and are used to direct the control of the inflow air impeding valve 22 and the intake fan 26. The controller operates the inflow air impeding valve 22 and the intake fan 26 to immediately provide the flow of air. The controller processes the signals from the sensors 91, and uses algorithms to predict, and then to assist, the user's next upcoming exhale of exhausted air. The algorithms are based on the always changing frequency and amplitude of the user's detected breathing pattern and are used to direct the control of the exhaust air impeding valve 63 and the exhaust fan 65. The controller operates the exhaust air impeding valve 63 and the exhaust fan 65 to immediately extract the exhaled air 61.

The controller operates the intake fan 26 to draw ambient air 24 from the ambient environment. The intake fan 26 draws the ambient air 24 through the intake filter 25, which substantially removes droplets of aerosolized pathogens that may be present in the ambient environment. The filtered air pressurizes at the inlet port of the manifold 28. The controller opens the one-way valve 31 and filtered air flows through the air inlet port 33 of the gas chamber 36. The gas chamber 36 mixes the filtered air and oxygen 38, if required. The controller opens the inflow air impeding valve 22 to provide the flow of air 20 to the user through the first face piece portion 19.

The gas canister 39 stores oxygen 38 which the user manually volume-regulates through the flow regulator 41. The oxygen 38 enters the gas chamber 36 through the gas inlet port 43.

Filtered air leaves the manifold 28 through a port 50, and enters the environment tube 54 which supplies pressurized, filtered air to the shroud 13. The user manually regulates the flow of air into the shroud 13 with the flow regulating valve 52. The positive pressure of the filtered air minimizes the possibility of ambient air 24 leaking into the shroud 13.

The controller processes information from the sensors 91 and detects the end of the user's inhalation. The controller then closes the inflow air impeding valve 22 to block the flow of air 20 to the user.

The second face piece portion 60 entrains and directs user-exhausted carbon dioxide, other gases, pathogens and moisture away from the user's nostrils and mouth through the outflow tube 62. The controller controls the exhaust air impeding valve 63 and the exhaust fan 65 to entrain and draw the exhaled air 61. The exhaust filter 66 reduces or eliminates pathogens, moisture, and carbon dioxide from entering the ambient environment through the exhaust tube 67, in order to avoid affecting people that may be in the vicinity of the user. This process of extracting exhaled air 61 substantially removes the exhaled carbon dioxide and other gases so they are not present at the user's next inhale.

The controller uses algorithms, the design and function thereof are based on the information and/or need supplied by the sensors 91. The rate of change of inhalation and exhalation is calculated, which allows the controller to predict, and then to assist, the user's next intake of filtered and mixed air. The algorithms are based on the frequency and amplitude of the user's detected and varying breathing pattern.

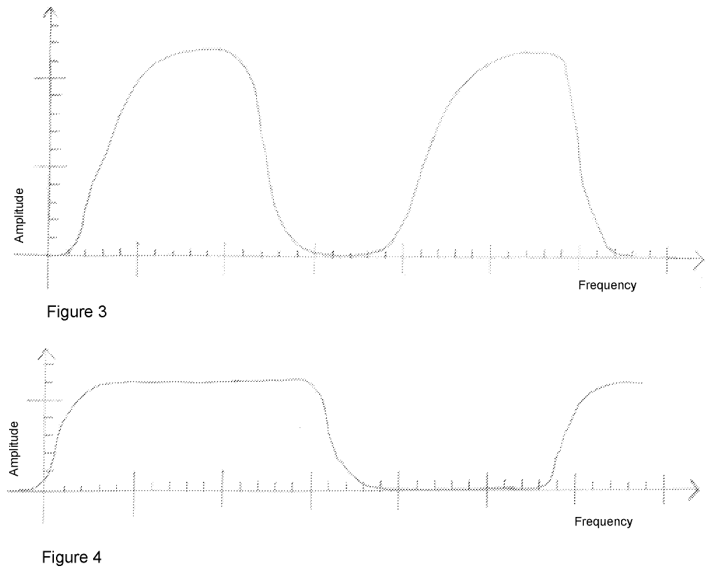

FIG. 3 shows two cycles of a generalised human breathing capnogram which approximately corresponds to the breathing pattern of a person, shown in FIG. 3 as a waveform. Segments of the breathing pattern are detected by the sensors 91 and are used by the controller to predict and report the user beginning to inhale. Other segments of the breathing pattern are detected and used to predict and report the user beginning to exhale.

FIG. 4 shows one cycle of the generalised human breathing capnogram of the same person as in FIG. 3. Comparing this cycle to that of the breathing pattern in FIG. 3, the amplitude of the waveform is greater in FIG. 3. The frequency of the waveform in FIG. 3 is also greater than the frequency shown in FIG. 4. Therefore, the person is breathing more quickly and more deeply in FIG. 3 than in FIG. 4.

Based on the breathing cycles in FIG. 3 and FIG. 4, the sensors 91 detect the variation in air flow, and thus the breathing pattern, and send signals to the controller. The controller processes the information, calculates when the next upcoming inhale will occur, and controls the PAPR 10 components as appropriate. As the user is breathing more quickly and more deeply in FIG. 3, the controller will more quickly operate the inflow air impeding valve 22, the one-way valve 31, and the intake fan 26 to increase the flow of air 20 to the first face piece portion 19 and then operate the exhaust air impeding valve 63 and exhaust fan 65 at more frequent intervals to adequately extract the exhaled air 61.

As the user's breathing is slower and shallower in FIG. 4, the controller will more slowly operate the inflow air impeding valve 22, the one-way valve 31, and the intake fan 26 to reduce the flow of air 20 to the first face piece portion 19 and operate the exhaust air impeding valve 63 and the exhaust fan 65 at less frequent intervals to adequately extract the exhaled air 61 in comparison to FIG. 3. As the user's breathing pattern changes, this is detected, and the controller determines the control of the PAPR 10 components to react substantially instantaneously. This ensures that the PAPR 10 is not out of phase with the user's breathing pattern. The controller may also be used to predict the next inhale or exhale based on just known breathing patterns. As the user is working harder, or under more stress, their rate of breathing increases. The sensors 91 detect the parameters measured in association with the user's breathing (air movement, humidity level, carbon dioxide level, and instantaneous temperature) more quickly and more frequently than when the user is at rest. The information from the sensors 91 is provided to the controller at more frequent intervals, and the controller operates the components of the PAPR 10 accordingly, depending on the whether the user is about to inhale or exhale, more quickly and more frequently. When the user is at rest, or under less stress, their rate of breathing decreases. The sensors 91 detect the parameters measured in association with the user's breathing more slowly and less frequently than when the user is under stress. The information from the sensors 91 is provided to the controller at less frequent intervals, and the controller operates the components of the PAPR 10 accordingly, depending on the whether the user is about to inhale or exhale, more slowly and less frequently.

For simplicity and clarity of illustration, where considered appropriate, reference numerals may be repeated among the figures to indicate corresponding or analogous elements. In addition, specific details are set forth in order to provide an understanding of the examples described herein. However, it will be understood by those of ordinary skill in the art that the examples described may be practiced without these specific details. The description is not to be considered as limiting the scope of the examples described herein.

It will be appreciated that the examples and corresponding diagrams used herein are for illustrative purposes only. Different configurations and terminology can be used without departing from the principles expressed herein. For instance, components can be added, deleted, modified, or arranged with differing connection without departing from these principles.

Although in the examples described above, the second face piece portion 60 has four sensors 91 position inside, in other embodiments there may be a differing number of sensors present.

In other embodiments the sensors 91 may detect parameters other than air movement, humidity level, carbon dioxide level, and instantaneous temperature.

Although in the examples described above, the PAPR 10 includes a shroud 13 covering the user's head and shoulders, in other embodiments a face mask fitted to the user's face may be used.

Although in the examples described above, the face piece 18 comprises a first face piece portion 19 and a second face piece portion 60, in other embodiments the face piece 18 may be two combined face pieces or may be an integrated piece.

Although in the example described above, the sensors 91 are coupled to the second face piece portion 60, in other embodiments they may be coupled to the first face piece portion 19, or in any other manner to ensure the sensors 91 are able to sense the desired parameters.

Although in the examples described above, the controller is described as being housed in a small, wearable bag that may be worn around and supported by the user's shoulders 12, in other embodiments this may be a belt or other wearable means of housing the controller and other components. In the event that the user is not mobile, the small, wearable bag, belt, or similar, may be hung on an appropriate hanger, for example the end of a bed frame, an IV stand, or similar.

Although in the examples described above, in the case where the sensor 91 is sensing air movement, it is described as detecting air movement in both directions. In other embodiments the sensor 91 may be configured to detect air movement in one direction only, detecting either only inhaling or exhaling.

Other embodiments of the PAPR 10 may be used in professions other than healthcare, for example the fire service, astronauts, fighter pilots and other professions where there may be a requirement for breathing apparatus.

Although examples have been described above with reference to the accompanying drawings, those of skill in the art will appreciate that variations and modifications may be made without departing from the scope thereof as defined by the appended claims.

What is claimed is:

1. A breathing apparatus comprising:
a face piece comprising:
a first face piece portion configured to direct a flow of air towards a user when in use;
a second face piece portion configured to direct exhaled breath away from the user when in use; and
at least one sensor configured to monitor the user's breathing; and
a controller configured to adjust the flow of air to the first face piece portion and the extraction of exhaled breath from the second face piece portion in response to an output from the at least one sensor.

2. The breathing apparatus of claim 1, wherein the at least one sensor detects at least one of a variation in air movement, a variation in humidity level, a variation in carbon dioxide level, and a variation in instantaneous temperature.

3. The breathing apparatus of claim 1, further comprising a shroud for covering a user's head and shoulders.

4. The breathing apparatus of claim 1, further comprising a weight bearing assembly to rest on the user's shoulders.

5. The breathing apparatus of claim 1, wherein the first face piece portion is coupled to an inflow tube having an inflow air impeding valve, upstream from which are a gas chamber, a one-way valve, a manifold, an intake fan, and an intake filter.

6. The breathing apparatus of claim 5, wherein the controller is configured to control the inflow air impeding valve, the one-way valve, and the intake fan.

7. The breathing apparatus of claim 1, wherein the second face piece portion is coupled to an outflow tube having an exhaust air impeding valve, downstream from which are an exhaust fan and an exhaust filter.

8. The breathing apparatus of claim 7, wherein the controller is configured to control the exhaust air impeding valve and the exhaust fan.

9. The breathing apparatus of claim 5, wherein the manifold is coupled to an environment tube, having a flow regulating valve, for directing air into the shroud.

10. The breathing apparatus of claim 5, wherein a gas supply tube is coupled to the gas chamber and a gas canister, and includes a flow regulating valve for manually adjusting an output of the gas canister into the gas chamber.

11. The breathing apparatus of claim 5, wherein the controller is configured to:
calculate a rate of change of inhalation and a rate of change of exhalation based on an output of the at least one sensor;
control the inflow air impeding valve, the one-way valve, and the intake fan to provide the flow of air based on the rate of change of inhalation; and
control the exhaust air impeding valve and the exhaust fan to extract the exhaled air based on the rate of change of exhalation.

12. A method of adjusting air flow in a breathing apparatus, comprising:
providing a flow of air to a user through a first face piece portion of a face piece;
extracting exhaled air away from the user through a second face piece portion of the face piece;
sensing, with at least one sensor, a variation in the user's breathing; and
sending to a controller, by the at least one sensor, a signal representing the variation;
adjusting by the controller, in response to the signal, the flow of air through the first face piece portion and the extraction of exhaled air through the second face piece portion.

13. The method of claim 12, wherein the providing a flow of air comprises:
operating an intake fan, by the controller, to draw ambient air into an inflow tube;
filtering the ambient air to substantially remove contaminants; and
raising the pressure of the filtered air at a manifold.

14. The method of claim 13, wherein the providing the flow of air further comprises:
dividing the flow of filtered air between the inflow tube and an environment tube at the manifold; and
manually opening a flow regulating valve in the environment tube to supply a portion of the filtered air into the shroud.

15. The method of claim 14, wherein the providing the flow of air further comprises:
mixing a portion of filtered air with oxygen in a gas chamber; and
opening an inflow air impeding valve, by the controller, to supply the mixed air to the first face piece portion.

16. The method of claim 15, wherein supplying oxygen from a canister is manually controlled by the user.

17. The method of claim 12, wherein the extracting comprises:
opening an exhaust air impeding valve by the controller;
drawing exhaled air away from user's mouth and nostrils by an exhaust fan;
filtering the exhaled air through an exhaust filter to remove any contaminants; and
exhausting the filtered exhaled air.

18. The method of claim 12, wherein the sensing comprises sensing at least a variation in air movement.

19. The method of claim 12, wherein the adjusting comprises: analysing, by the controller, the output from the at least one sensor;
calculating, by the controller, a rate of change of the user's inhalation;
predicting, by the controller, the next upcoming inhale; and
controlling, by the controller, the inflow air impeding valve, the one-way valve, and the intake fan to provide the flow of air based on the rate of change of inhalation.

20. The method of claim 12, wherein the adjusting comprises: analysing, by the controller, the output from the at least one sensor;
calculating, by the controller, a rate of change of the user's exhalation;
predicting, by the controller, the next upcoming exhale; and
controlling, by the controller, the exhaust air impeding valve and the exhaust fan to extract the exhaled air based on the rate of change of exhalation.
